(19) United States
(12) Patent Application Publication
(10) Pub. No.: US 2025/0132112 A1
(43) Pub. Date: Apr. 24, 2025

(54) CIRCUIT INTERRUPTER, CONDUCTOR THEREFOR AND METHOD OF MAKING SAME

(71) Applicants: Ludwig MARKER, Grillenberg (AT); Kurt AIGNER, Wien (AT); Sami RASSY, Baden (AT); Dietmar HABA, Kottingbrunn (AT); Brkic MAHIR, Mattersburg (AT); Wolfgang ART, Neudoerfl (AT)

(72) Inventors: Ludwig MARKER, Grillenberg (AT); Kurt AIGNER, Wien (AT); Sami RASSY, Baden (AT); Dietmar HABA, Kottingbrunn (AT); Brkic MAHIR, Mattersburg (AT); Wolfgang ART, Neudoerfl (AT)

(21) Appl. No.: 18/727,417

(22) PCT Filed: Jan. 25, 2023
(86) PCT No.: PCT/AT2023/060016

§ 371 Date: Jul. 9, 2024

(30) Foreign Application Priority Data
Jan. 25, 2022 (AT) A 50031/2022

(51) Int. Cl. H01H 39/00; B29C 45/14; B29C 45/38; B29L 31/34; H01B 13/32

(52) U.S. Cl. CPC H01H 39/006; B29C 45/38; H01B 13/322; B29C 45/14; B29L 2031/3425

(57) ABSTRACT

The aim of the invention is to produce a conductor (14) for a circuit breaker (11), said conductor having a printed circuit board (14c) to be separated between two conductor ends and additionally having a conductor encapsulation (15) that has a cavity (20) in which the printed circuit board (14c) is located. This is achieved in that a plastic melt is injected, via at least one gate (21), into an injection mold, in which the conductor (14) is located. According to the invention, the gating process (21) is carried out from out of the cavity (20), through which the conductor passes, wherein the plastic melt flows from the gate (21) to the actual conductor encapsulation (15) through a runner (22; 24a-24d; 26a, 26b). In the process, the gate (21) can remain in the completed circuit breaker (11).

### FIELD OF THE INVENTION

The present invention relates to a method of making a conductor for a circuit interrupter having a circuit board to be severed between two conductor ends, the conductor having a conductor overmolding forming a cavity holding the circuit board, molten plastic being injected through a sprue of an injection mold holding the conductor. It also relates to a conductor that can be made by such a method with a conductor overmolding as well as a circuit interrupter with such a conductor.

### STATE OF THE ART

Pyrotechnic circuit interrupters are now being used more and more in electric vehicles. The reason for this is that vehicles with low power can be reliably protected by a combination of gates and fuses, whereas medium and high power vehicles have a current range between the current-carrying and isolating capacity of the gates and the timely tripping range of the fuse that is not adequately protected. There are many examples of circuit interrupters in the high-voltage range where AT 522735 [U.S. Pat. No. 11,908,647] of Hirtenberger shows a typical design. The characteristic element of this current separator with a greatly reduced external effect is overmolding the conductor, which avoids or at least minimizes a continuous gap between the plastic of the housing and the conductor, thereby preventing hot gases from escaping.

WO 2021/168493 [US 2023/0037447] also shows an assembly with a pyrotechnic current separator with conductor, separating plunger and conductor encapsulation, where projections are provided in injection molds so that the conductor is notched during injection molding. This represents a cost-effective possibility for notching the conductor.

WO 2021/207773 describes a pyrotechnic circuit interrupter with a similar structure to WO 2021/168493 [U.S. Pat. No. 6,402,495] however describes how, at least one predetermined fracture line of the conductor is coated with polymer material to improve the stability of the ladder.

DE 10065535 [U.S. Pat. No. 6,402,495] describes a method of making a busbar at least partially encapsulated with casting resin for connecting a motor vehicle lamp unit, the manufacturing method using a casting mold that guides the casting resin to the busbar via a sprue and a sprue manifold, the busbar partially cast with casting resin having a cavity and the sprue and the sprue manifold being in a lateral edge region of the busbar outside the cavity.

JP H0774451 describes a method of making a molded printed circuit board assembly having a cavity that holds a flexible printed circuit board in a mold for manufacture and the thermoplastic resin flows to the flexible printed circuit board via a sprue that extends from the cavity.

In injection molding, a distinction is made between sprue, runner, gate and the actual injection molded part. Sprue refers to the feed pipe that normally expands conically, or the material that remains there after demolding. Sprue manifolds are the passages that extend from the end of the sprue to the actual injection-molded part or the material that remains there after demolding. A sprue manifold is only necessary if the sprue does not flow directly into the actual injection molded part. The gate is the transition from the sprue (or, if present, from the sprue manifold) to the actual injection molded part. Normally, the sprue manifold and sprue are separate from the injection molded part. Finally, a filling space is sometimes also provided between the sprue and the sprue manifold so that the passages of the sprue manifold are evenly supplied (filled) with material. The material remaining there after demolding is referred to below as filling-space plastic.

Up to now, a conductor overmolding has been produced by (at least) two external gates from the outside. The difficulty with these methods of conductor overmolding lies in the distortion of the conductor overmolding and the formation of weld lines in the area of the conductor overmolding that is particularly exposed to pressure from a possible arc, because the material already cools down considerably on the way to inside where the arc is formed. A weld line is the area where the plastic from one sprue (or one passage of a sprue manifold) joins with the plastic from another sprue (or another passage). The strength is often reduced at this point because the plastic is already relatively cool at the time of merging, i.e. the two plastic strands no longer completely fuse together.

### SUMMARY OF THE INVENTION

It is the object of the present invention to provide a method of the above-mentioned species where these difficulties are less pronounced.

This object is attained by a process of the invention of the above-described type in that the sprue extends from the cavity through which the conductor passes so the molten plastic flows from the sprue to the actual conductor overmolding through a sprue manifold.

According to the invention, injection molding is thus carried out from the inside to the outside so that the material is still relatively hot inside of the injection mold, i.e. at the edge of the cavity where the arc is formed, when it flows together from different passages of the runner. Warping is also reduced because the manifold makes it difficult for the injection molded part to shrink in different directions.

The sprue together with the sprue manifold can be removed from the conductor overmolding, This is possible in a simple way in the injection mold, for example by punching or by an ejector.

Alternatively, it is possible to provide for the conductor to have a hole and for the sprue to be separated by a punch that is guided through this hole. When producing the conductor overmolding, care should be taken to ensure that the sprue behind the hole does not have an increase in cross-section if possible, so as not to make separation unnecessarily difficult.

A third option is to remove the sprue together with the sprue manifold by twisting the sprue.

In some cases, however, the sprue remains on the conductor overmolding, resulting in a conductor on which the sprue and sprue manifold are present in the cavity of the conductor overmolding. This allows further functions to be achieved, such as centering the circuit board during further assembly of the circuit interrupter. When the circuit interrupter is triggered, the sprue together with the sprue manifold is severed from the conductor overmolding in the area of the gates. In the case of a circuit interrupter in which such a conductor is installed, the circuit board can be braked during the isolating process: The usually conical sprue can be braked in a cylindrical hole, for example.

The strength of the connection between the sprue and the PCB can be increased if the sprue manifold is at least partially umbrella-shaped. By “umbrella-shaped” it is understood that the sprue manifold has the shape of a circular disk; by “partially umbrella-shaped” it is understood that it has the shape of at least one sector of a circle. Compared to thin passages, an umbrella-shaped or partially umbrella-shaped design ensures a more even distribution of the liquid plastic and also a more stable connection between the conductor overmolding and the sprue. The sprue manifold that can consist of several passages or, as just mentioned, can also be umbrella-shaped, can be supplied with the molten plastic directly from the sprue or via a filling chamber. A supply via a filling chamber has the advantage during manufacture that the plastic melt is distributed evenly, which is otherwise difficult to achieve, especially with an umbrella-shaped sprue manifold. In this case, the finished product has filling-space plastic between the sprue and the sprue manifold that extends further toward the wall of the cavity than the sprue. As the filling-space plastic is normally in contact with the conductor, this also increases the strength of the connection between the sprue and conductor.

In order to increase the strength of the connection between the sprue and the board, it is further advantageous if the board has a hole and at least part of the sprue extends through this hole and preferably has a larger cross-section behind the hole than corresponds to the cross-section of the hole. In contrast to the design described above, in which the sprue is cut off through the hole by a punch, an increase in cross-section behind the hole is favorable here.

According to one embodiment of the invention, it is provided that the sprue manifold is formed by a plurality of passages whose connection to the conductor overmolding takes place in the lateral edge region of the conductor, in particular that the connections of the passages to the conductor overmolding are at predetermined fracture lines of the conductor. This means that the gates are located where the lateral edges of the conductor enter the conductor overmolding. This can be realized, for example, by four gates next to the conductor in the conductor plane. In this case, the geometry of the groove (usually U, V or W-shaped) can be continued in the gate area. This is advantageous in that the core of the injection mold having a projection, which projects into the predetermined fracture lines, can be designed to be circularly symmetrical. The predetermined fracture lines are then partially filled with plastic, namely in the remaining gap between the projection of the core and the predetermined fracture line.

It is advantageous if the passages are opposite each other in pairs, relative to the axis of the cavity of the conductor overmolding. This symmetry minimizes distortion during cooling. It is particularly favorable if there is also symmetry with respect to the plane containing the longitudinal axis of the conductor and the axis of the cavity and/or with respect to the plane containing the normal to the longitudinal axis of the conductor and the axis of the cavity.

Alternatively, however, it is also possible to provide that the connection of the sprue manifold to the conductor overmolding lies in a plane that is spaced from the conductor, preferably by a distance of at least 1 mm, particularly preferably at least 2 mm. This results in a particularly high insulation resistance after the separation process. This is due to the fact that the sprue is also severed from the conductor overmolding during the conductor separation process, specifically in the area of the gates. This creates rough areas on which residues from the copper burn-off preferentially settle after separation. If these do not have direct contact with the conductor, this is favorable for insulation resistance. In the simplest case, this distance is formed by offsetting the parting planes of the cores of the overmolding die, provided that the gate is made on this plane. The offset is preferably in the direction of the igniter.

A spacing between the gates and the conductor is also provided if the sprue manifold has two manifold passages that are perpendicular to the longitudinal axis of the conductor. This arrangement allows the distortion of the cavity to be kept to a minimum. Without special measures, shrinkage in the area of the conductor would be less than at right angles to it, because the conductor counteracts the shrinkage. If the passages are perpendicular to the longitudinal axis of the conductor, they also offer resistance to shrinkage in this direction, which reduces the deviation from the ideal circular cross-section. Another advantage is that the weld lines form in the area reinforced by the conductor.

As mentioned above, the gates can be located in the area of the conductor, which in particular requires that they lie in the conductor plane. For this purpose, it is useful if the conductor has a cross-section reduction in the area where it enters the conductor overmolding, and the cross-section reduction is preferably formed by lateral notches on the conductor. In this way, additional space is available for the gates.

As previously described for the variant with the sprue remaining in the conductor overmolding, in the variants with the gate removed the gate can also be in contact with the conductor or removed from it. If the gates are not in contact with the conductor, the same advantages arise as described above. This also applies to moving the gates out of the conductor plane.

### BRIEF DESCRIPTION OF THE DRAWING

The present invention is described in more detail with reference to the accompanying drawings. Therein:

FIG. 1A shows a pyrotechnic circuit interrupter with a lower housing part, an upper housing part and a conductor overmolding, with a sprue and a shield-shaped sprue manifold;

FIG. 1B shows the conductor overmolding from below;

FIG. 1C is a plan view of the conductor;

FIG. 1D a section along the line 1d-1d of FIG. 1B;

FIG. 1E a section along the line Ie-Ie of FIG. 1B;

FIG. 2A shows another embodiment of a conductor overmolding from below, with four diagonal manifold passages;

FIG. 2B is a section along line IIb-IIb of FIG. 2A;

FIGS. 3A and 3B are views similar to FIGS. 2A and 2B, but with a filling space between the sprue and manifold passages;

FIGS. 4A and 4B are views similar to FIGS. 3A and 3B, but with a conductor with a central hole;

FIG. 5A shows another embodiment of a conductor overmolding from below, with two manifold passages extending normal to the longitudinal axis;

FIG. 5B is a section along the line Vb-Vb of FIG. 5A;

FIG. 5C is a section along the line Vc-Vc of FIG. 5A; and

FIGS. 6A to 6C are views similar to FIGS. 5A to 5C, but with gates below the conductor plane and with a conductor with a central hole.

### WAY(S) TO CARRY OUT THE INVENTION

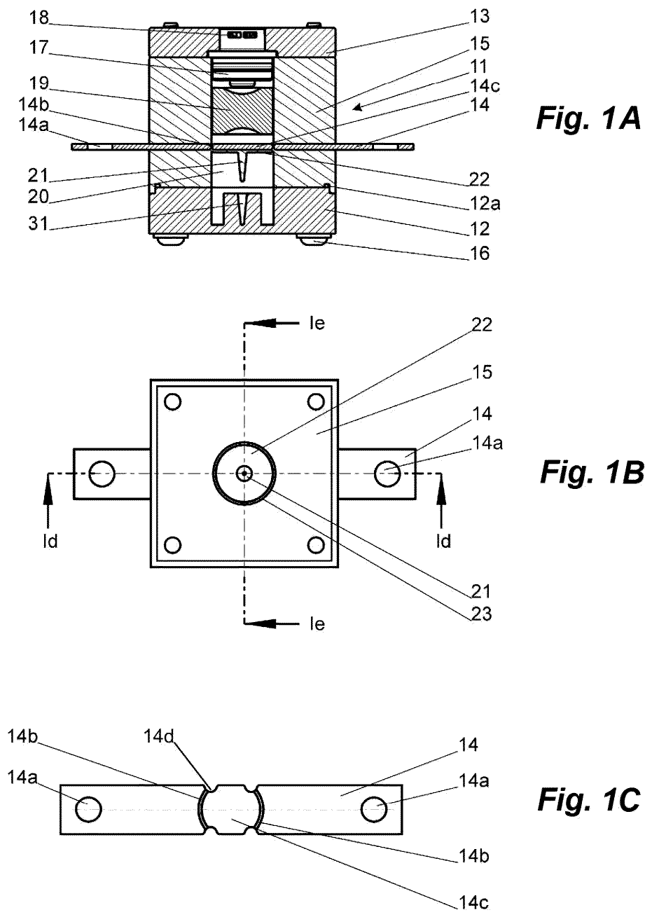

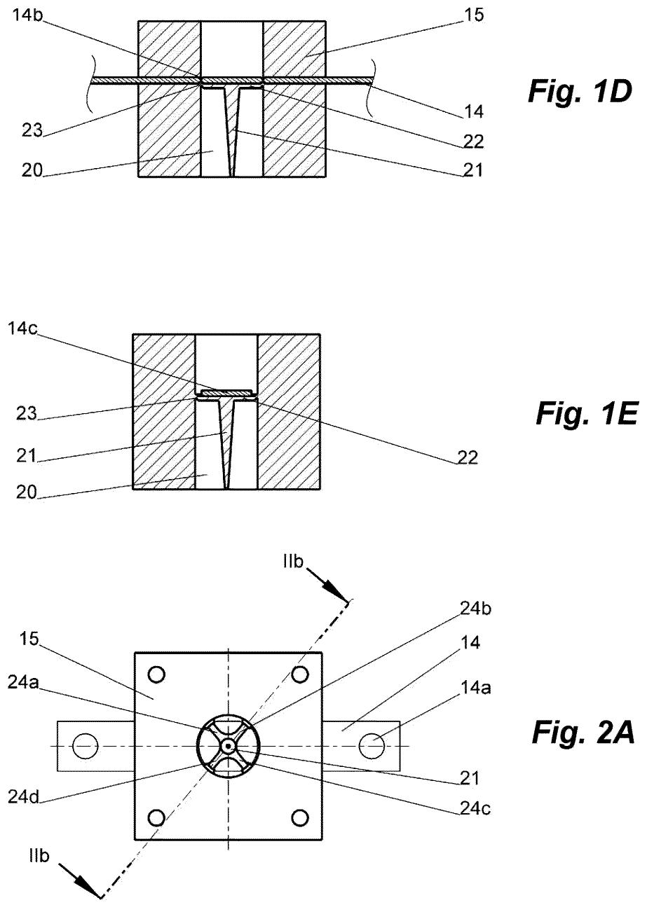

FIG. 1A shows a pyrotechnic circuit interrupter 11 having a housing comprised of a lower housing part 12, an upper housing part 13 and therebetween a conductor 14 set in an intermediate injection-molded part 15. The parts are held together by four screws 16.

The conductor overmolding 15 is formed by placing the conductor 14 in an injection mold and then injection molding the conductor overmolding 15 around it. This has the advantage that there can be no gap between the conductor overmolding 15 and the conductor 14 due to the manufacturing process; instead the conductor overmolding 15 lies tightly against the conductor 14 even without any additional seals. To seal the housing, it is therefore sufficient to seal the lower housing part 12 and the upper housing part 13 against the conductor overmolding 15 that is relatively easy to do because injection-molded parts do not have any sharp edges, unlike the conductor 14 produced by stamping. For example, a groove 12a can be provided into which a O-ring is inserted.

The conductor overmolding 15 has a central cavity 20. A separating piston 19 is in it between the conductor 14 and the upper housing part 13. A pyrotechnic igniter 17 is in the upper housing part 13. It can be connected to an electronic circuit by a plug 18. When the electronic circuit generates an ignition signal, the igniter 17 abruptly generates a superatmospheric pressure that presses the separating piston 19 against the conductor 14 and thus breaks out a middle section of the conductor 14, referred to below as a circuit board 14c.

In order to facilitate this, the conductor 14 (see also FIG. 1C) has on both sides of the circuit board 14c predetermined fracture lines 14b that are in the form of grooves. In addition, recesses or notches 14d are provided at the end of these grooves so that not only the thickness of the conductor 14 is reduced in the area of the predetermined fracture lines 14b, but also its width. In this way, the board 14c can be easily punched out by the separating piston 19 (see FIG. 1a). The conductor 14 (see also FIG. 1C) has holes 14a at its ends so that a cable can be screwed onto each end. As long as the conductor 14 is intact, the two screwed-on cables are electrically connected to each other. As soon as the circuit board 14c is punched out, they are electrically disconnected from each other. In this way, very high voltages (e.g. 500 V) can be disconnected, even if very high currents (e.g. 2000 A) are flowing.

For the simplest possible manufacture of the conductor overmolding 15, a central sprue 21 (see also FIGS. 1B, 1D and 1E) is provided, formed by the liquid plastic fed into the injection mold. It flares to the outside via an umbrella-shaped manifold formation 22, where it forms the actual conductor overmolding 15. The transition between the sprue manifold formation 22 and the actual conductor overmolding 15 is referred to below as a gate 23. The sprue 21 together with the sprue manifold 22 can be severed at the gate 23 as will be explained below.

According to a preferred embodiment of the invention, the sprue 21 remains in the circuit interrupter 11. If a corresponding recess 31 is provided in the lower housing part 12 (see FIG. 1A), the combination of sprue 21 and recess 31 acts as a guide for the board 14c when it is moved down by the separating piston 19, and with appropriately selected diameters a relatively gentle braking of the board 14c can also be achieved as a result.

As can be seen in particular from FIG. 1D, the plastic of the conductor overmolding 15 fills the grooves of the predetermined fracture lines 14b on the side facing the sprue 21, thereby stabilizing the conductor 14.

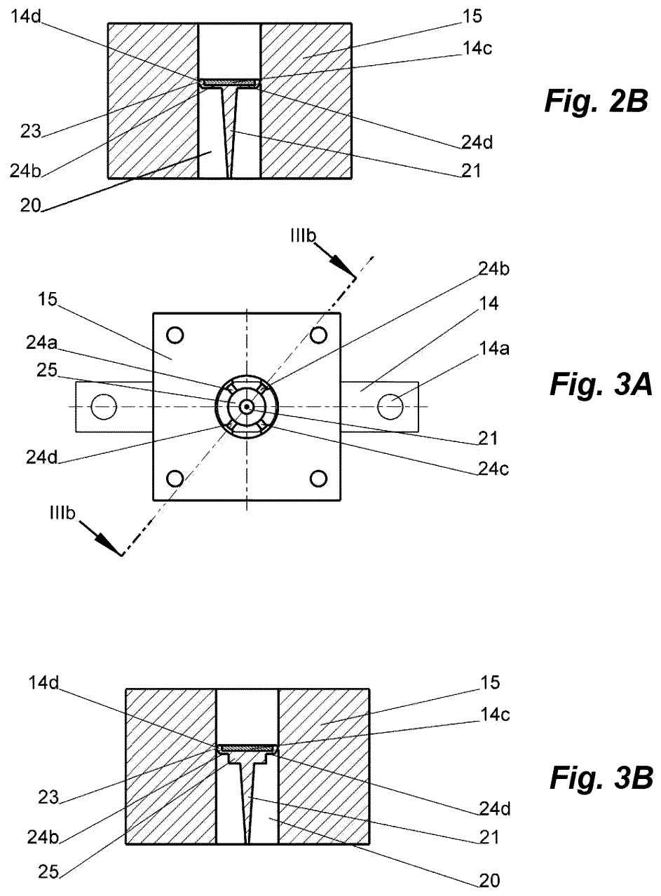

The embodiment shown in FIGS. 2A and 2B differs from the embodiment described above in that four distribution passages 24a to 24d are provided instead of the shield-shaped sprue manifold 22. These distribution passages 24a to 24d each form an angle of around 45° with the longitudinal axis of the conductor 14, so that they fill the recesses 14d (see FIG. 1C) of the conductor 14. In this way, the gates 23 (see FIG. 2B) can be level with the conductor or circuit board 14c.

The embodiment according to FIGS. 3A and 3B differs from the embodiment according to FIGS. 2A and 2B only in that there is a filling space between the sprue 21 and the distribution passages 24a-d during injection molding, which is helpful for the uniform distribution of the plastic into the four distribution passages 24a-d. The plastic remaining there is referred to as filling-space plastic 25. It improves the connection between the sprue 21 and the board 14c.

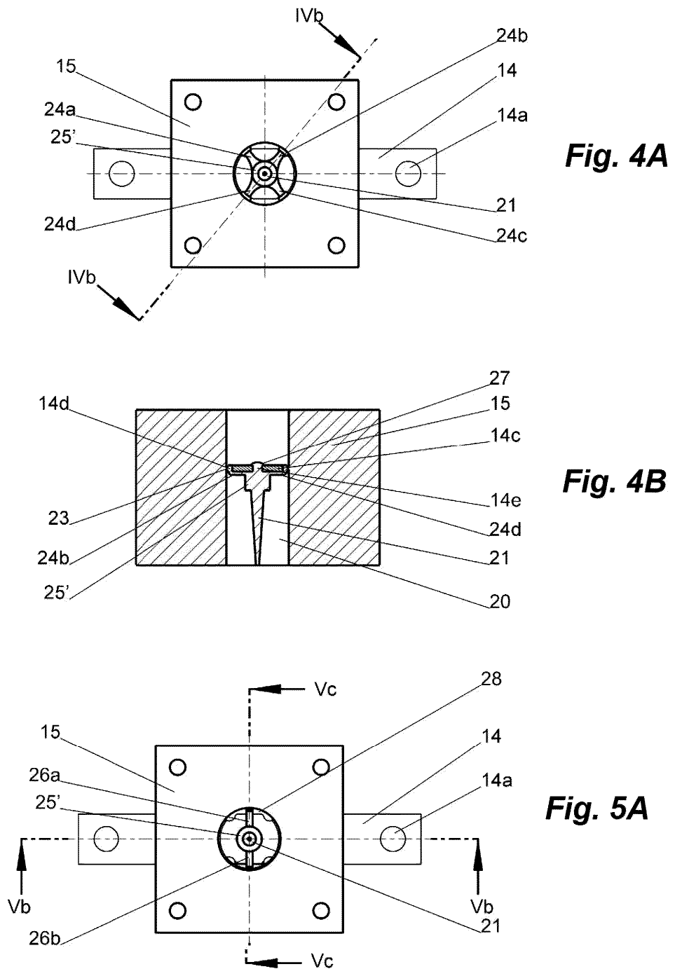

This connection can also be stabilized by the fact that a central hole 14e (see FIG. 4B) is provided in the board 14c (see FIG. 4b) through which the plastic passes during injection molding and forms a widened head 27 on it. In this way, a form-fit connection is created between the sprue 21 and the board 14c, so that the diameter of the filling-space plastic 25′ can be smaller than in the above-described embodiment according to FIGS. 3A and 3B.

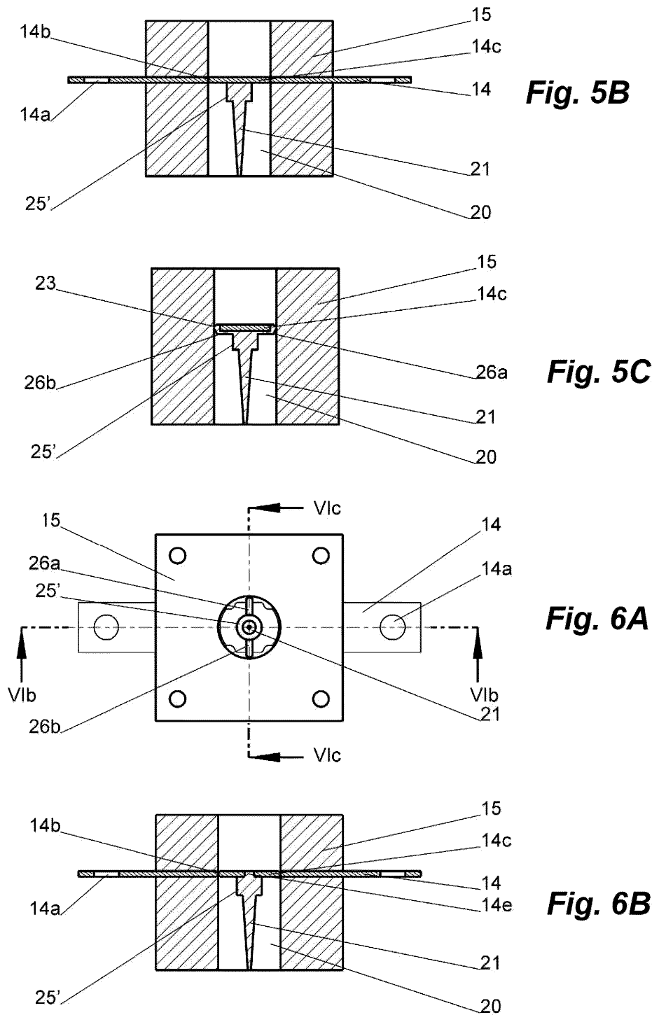

FIGS. 5A to 5c show an embodiment in which two distribution passages 26a, 26b are provided. These two distribution passages 26a, 26b extend perpendicular to the longitudinal axis of the conductor 14. Since the width of the conductor 14 is smaller than the diameter of the cavity 20, the gates 23 can be located at the height of the conductor 14 or the circuit board 14c. The area 28 between the conductor 14 and the conductor overmolding 15 can be free, but it can also be filled with plastic.

However, the gates 23 can also be located below this, as shown in FIGS. 6A to 6C. This embodiment also differs from the embodiment just described in that the board 14c has a central hole 14e, as is the case in the embodiment according to FIG. 4B. Here, however, the plastic does not emerge into the area above the board 14c, so that the sprue 21 together with the filling-space plastic 25′ and the distribution passages 26a, 26b can be easily severed at the gates 23 by pressing on the hole 14e from above with the piston.

1. A method of making a conductor for a circuit interrupter having a circuit board to be severed between two conductor ends, the conductor having a conductor overmolding forming a cavity holding the circuit board, molten plastic being injected through a sprue of an injection mold holding the conductor, wherein the sprue extends from the cavity holding the conductor, the molten plastic flowing from the sprue through a sprue manifold to the conductor overmolding.

2. The method according to claim 1, wherein the sprue together with the sprue manifold are separated from the conductor overmolding before they are installed in the housing of the current interrupter.

3. The method according to claim 2, wherein the sprue is severed the conductor overmolding.

4. The method according to claim 3, wherein the sprue is separated or punched out by at least one ejector.

5. The method according to claim 2, wherein the sprue together with the sprue manifold are removed by twisting the sprue.

6. The method according to claim 2, wherein the conductor has a hole and the sprue is separated by a punch that is passed through this hole.

7. A conductor with conductor overmolding, manufactured according to claim 1, wherein the conductor overmolding has a cavity, in which a printed circuit board is located, and a sprue, and the sprue together with the sprue manifold are in the cavity of the conductor overmolding.

8. The conductor according to claim 7, wherein the sprue manifold is at least partially umbrella-shaped.

9. The conductor according to claim 7, wherein between the sprue and the sprue manifold there is filling-space plastic that extends further in the direction of the wall of the cavity than the sprue.

10. The conductor according to claim 7, wherein the circuit board has a hole and at least a part of the sprue extends through this hole and preferably has a larger cross-section past the hole than the cross-section of the hole.

11. The conductor according to claim 7, wherein the sprue manifold is formed by a plurality of passages whose connection to the conductor overmolding takes place in the lateral edge region of the conductor.

12. The conductor according to claim 11, wherein the connection of the passages to the conductor overmolding extends to predetermined fracture lines of the conductor.

13. The conductor according to claim 11, characterized wherein the passages are located opposite one another in pairs relative to the axis of the cavity of the conductor overmolding.

14. The conductor according to claim 7, wherein the connection of the sprue manifold to the conductor overmolding is in a plane spaced from the conductor, preferably by a distance of at least 1 mm, particularly preferably by at least 2 mm.

15. The conductor according to claim 14, wherein the sprue manifold has two manifold passages that are perpendicular to a longitudinal axis of the conductor.

16. The conductor according to claim 7, wherein the conductor has a reduction in cross-section in the region where it enters the conductor overmolding.

17. The conductor according to claim 16, wherein the cross-sectional reduction is formed by laterally open notches on the conductor.

18. A circuit interrupter having a housing, a pyrotechnic detonator and a separating piston for separating a circuit board from a conductor, wherein the conductor is formed with conductor overmolding according to claim 7.
